(19) United States
(12) Patent Application Publication
(10) Pub. No.: US 2006/0106879 A1
(43) Pub. Date: May 18, 2006

(54) Conflict resolution in a synchronization framework

(75) Inventors: Quinton Y. Zondervan, Cambridge, MA (US); Stephen T. Auriemma, Chelmsford, MA (US); Sesha S. Baratham, Acton, MA (US); Maria M. Corbett, Lexington, MA (US); Michael R. O'Brien, Westford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/989,565

(22) Filed: Nov. 16, 2004

(51) Int. Cl. G06F 17/30

(52) U.S. Cl. 707/200

(57) ABSTRACT

A method, system and apparatus for detecting and resolving conflict resolution in a synchronization framework. In this regard, a synchronization framework which has been configured in accordance with the present invention can include a synchronization engine configured for coupling to an application utilizing a data set subject to synchronization with another application. The framework further can include a synchronization adapter communicatively linked to the synchronization engine. Finally, the framework can include conflict detection and resolution logic disposed within the synchronization framework and configured for communication with one of the synchronization engine and the synchronization adapter.

### BACKGROUND OF THE INVENTION

1. Statement of the Technical Field

The present invention relates to the field of data synchronization and more particularly to the use of a synchronization framework to provide data synchronization services.

2. Description of the Related Art

Personal computers no longer are the most common vehicle through which users connect to data communications networks like the Internet. Now that computing can be viewed as being truly everywhere, computer scientists and information technologists have begun to rethink those services that can be provided to meet the needs of mobile computing users. In consequence, the study of pervasive computing has resulted in substantial innovation in the field of network connectivity. “Pervasive computing” has been defined as referring to any non-constrained computing device not physically tethered to a data communications network. Thus, pervasive computing devices refer not only to computers wirelessly linked to networks, but also to handheld computing devices, wearable systems, embedded computing systems and the like.

Most pervasive devices, including notebook computers, handheld computers and even data enabled cellular telephones permit data synchronization with a different computing device, for example a desktop computer. Data synchronization refers to the harmonization of data between two data sources such that the data contained in each data source can be reconciled notwithstanding changes to the data applied in either or both of the data sources. Modern pervasive devices provide for a synchronization process through a direct cable link, a modem link, or a network link to a host computing device. Wireless pervasive devices further can accommodate synchronization over infrared or radio frequency links.

To facilitate the synchronization of disparate devices hosting different applications, synchronization frameworks like the framework specified by “SyncML” have been proposed. Generally, a synchronization framework defines an interoperable protocol for data synchronization between heterogeneous data stores on pervasive devices and connected servers. Such synchronization frameworks further define the message exchange between client and server to accomplish synchronization. Yet, by design, synchronization frameworks do not specify the actual process required to accomplish a synchronization. In particular, synchronization frameworks do not dictate any particular methodology for detecting and resolving conflicts between client and server.

Because a record can be updated in both client and server versions of a data set during a window of time between synchronizations, update conflicts are common. Notwithstanding, as there is no generally accepted way to resolve conflicts, conflict detection and resolution has been relegated from the synchronization framework to the individual applications implementing the actual synchronization process for data sets managed and utilized within the individual applications. In fact, while the SyncML protocol can be cognizant of the fact that during synchronization, conflicts can occur between updates made at the server and updates made at the client, how to detect such conflicts and what to do with those conflicts is left entirely to the application.

### SUMMARY OF THE INVENTION

The present invention addresses the deficiencies of the art in respect to data synchronization and provides a novel and non-obvious method, system and apparatus for detecting and resolving conflict resolution in a synchronization framework. In this regard, a synchronization framework which has been configured in accordance with the present invention can include a synchronization engine configured for coupling to an application utilizing a data set subject to synchronization with another application. The framework further can include a synchronization adapter communicatively linked to the synchronization engine. Finally, the framework can include conflict detection and resolution logic disposed within the synchronization framework and configured for communication with one of the synchronization engine and the synchronization adapter.

The conflict detection and resolution logic further can include a set of rules governing conflict resolution for data sets passed to the synchronization engine. The rules can include a static mapping of conflict types to conflict resolutions. Also, the rules can include a dynamic mapping of conflict types to conflict resolutions. In either case, the framework can include a sync server agent configured for communication with a sync client agent through the synchronization adapter. In a preferred aspect of the invention, the synchronization framework can implement a SYNCML framework.

In a synchronization framework, a conflict detection and resolution method can include the steps of receiving an update from a client application for application in a server application; detecting and resolving conflicts for the received update in the synchronization framework; and, selectively applying the update in the server application. The detecting step can include the step of determining whether a data set implicated by the received update exists in the server application. The detecting step also can include the step of determining whether a data set implicated by the received update in the server application has been modified by the server application.

The resolving step can include the steps of determining a conflict type for the update, selecting a conflict resolution based upon the determined conflict type; performing the selected conflict resolution, and applying the update subsequent to performing the selected conflict resolution. In this regard, the conflict types can include replace-replace, replace-delete, delete-replace, replace-add, add-replace, add-add, add-delete, delete-add, and delete-delete. Additionally, the conflict types can be extended to include other conflict types. By comparison, the conflict resolution can include latest wins, client wins, server wins, update wins, delete wins, local wins, remote wins, duplicate, merge. merge else duplicate, no resolution, defer, error, and already exists. As before, the set of possible conflict resolutions can be extended to included other conflict resolutions.

Once the conflict has been resolved in the server, a result of the conflict resolution can be presented to the client as a new update to the client. Additionally, a notification of the conflict and its resolution can be provided to the client. In another example, the conflict resolution may produce a duplicate document containing the server update. In this case, a copy of data set can be created at the server. The client update then can be applied to the copy of the data set at the server. Subsequently, in lieu of sending the resolved update to the client, the copy of the data set can be provided to the client and the client can be notified that the copy of the data set was created in response to a conflicting update. This allows the client to provide a user interface by which the user can manually resolve the conflict at the client after synchronization has completed.

An important aspect of the present invention can include the client always receiving the correct update from the server based upon the outcome of the conflict resolution, as well as a notification describing the result of the conflict resolution and identifying any new objects that were created during the conflict resolution. It will further be recognized that that client and server are used to describe roles, rather than physical entities. Finally, conflict resolution may take place on either or both systems participating in the synchronization.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a synchronization framework configured for conflict resolution in accordance with the present invention; and,

FIG. 2 is a flow chart illustrating a conflict resolution process for use in the synchronization framework of FIG. 1.

### DETAILED DESCRIPTION OF THE PREFERRED EMBODIMENTS

The present invention is a method, system and apparatus for conflict resolution in a synchronization framework. In accordance with the present invention, conflict resolution logic can be disposed in a synchronization framework. The conflict resolution logic can incorporate one or more conflict resolution rules. Additionally, the conflict resolution logic can include an interface to coupled applications. In this way, in the course of a synchronization operation, when a conflict is detected either internally within the framework, or externally in the coupled applications, the conflict resolution logic can apply the resolution rules in determining when and how to perform the synchronization.

In one aspect of the invention, the synchronization framework can be arranged to implement and extend the SyncML framework defined by Open Mobile Alliance Ltd. Specifically, the synchronization framework can provide the interfaces and common classes for conflict detection and conflict resolution on behalf of supported applications. The synchronization framework further can accommodate conflict detection and resolution at both the server and client in a “heavy version”, and only at the server in a “light” version so as to keep the implementation of the client as thin and lightweight as possible.

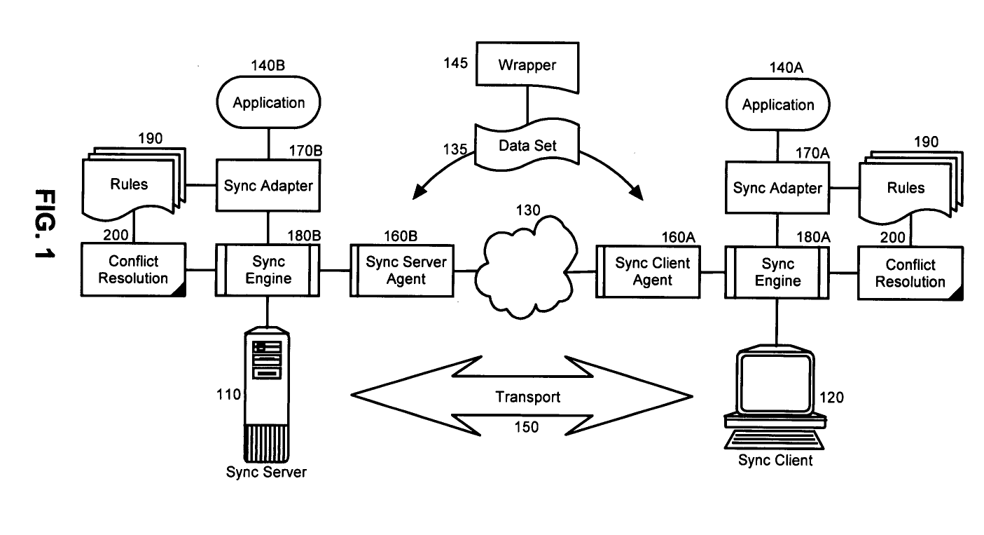

In more particular illustration, FIG. 1 is a schematic illustration of a synchronization framework configured for conflict resolution. The synchronization framework can support the synchronization of a data set 135 as between client and server applications 140A, 140B. The client application 140A can be hosted within a sync client 120, and the server application 140B can be hosted within a sync server 110. The sync client 120 can include a sync adapter 170A and the sync server 110 also can include a sync adapter 170B. The sync adapters 170A, 170B can be arranged for communication over a computer communications medium 130 via sync agents 160A, 160B utilizing a common network transport 150, such as the hypertext transfer protocol (HTTP). In this regard, the sync agents 160A, 160B can include a synchronization protocol layer such as a protocol layer based upon the SyncML protocol.

Importantly, respective sync engines 180A, 180B can be coupled to the sync adapters 170A, 170B. Each sync engine 180A, 180B can be an implementation of a data synchronization protocol corresponding to the framework, for instance a SyncML engine. In this regard, each sync engine 180A, 180B can manage a synchronization process between the client and server applications 140A, 140B for the data set 135. In furtherance of the synchronization management function, the sync engines 180A, 180B can access the network 130 through the sync agents 160A, 160B in order to communicate data synchronization operations to and from the client application 140A.

The sync adapters 170A, 170B can provide a main entry point for call backs from the sync engines 180A, 180B. The sync adapters 170A, 170B can be called when the synchronization process begins, and when the synchronization session ends. The sync adapters 170A, 170B further can be called for each update received from the client application 140A or the server application 140B. Finally, each of the sync adapters 170A, 170B can be configured to register with a respective one of the sync engines 180A, 180B to receive event notifications for synchronization events, including conflict detection events and conflict resolution events.

Significantly, each of the sync engines 180A, 180B can include conflict resolution logic 200. The conflict resolution logic 200 can detect and resolve conflicts in synchronizing the data set 135. Notably, the conflict resolution logic 200 can be incorporated as part of either or both of the sync engines 180A, 180B and the sync adapters 170A, 170B. To the extent that the conflict resolution logic 200 is included as part of both the sync engines 180A, 180B and the sync adapters 170A, 170B, the sync adapters 170A, 170B can perform conflict detection and resolution first, but the sync adapters 170A, 170B can defer to the respective one of the sync engines 180A, 180B. In this case, the conflict resolution logic 200 associated with the sync adapters 170A, 170B can override the default behavior of the conflict resolution logic 200 associate with the sync engines 180A, 180B and the sync engines 180A, 180B can maintain an awareness of the outcome of conflict resolution when performed by the sync adapters 170A, 170B.

To provide guidance in resolving detected conflicts, one or more conflict resolution rules 190 can be applied by the conflict resolution logic 200. These conflict resolution rules 190 can specify both a conflict type such as replace, delete or add, and conflict resolution solutions, such as “client wins”, “last update wins”, “server wins” to name only a few. Other conflict types can be defined within the applications 140A, 140B. More specifically, conflict detection can be performed the version of a data set 135 in the server application 140B with the version of the data set 135 in the client application 140A. The conflict resolution logic 200 can determine the type of conflict implicated by the comparison based upon the type of update to be applied to the data set 135.

Predefined conflict resolution types can include the following:
Replace-Replace: Both the client and server versions of the data set have been modified, each version intending to replace the other;
Replace-Delete: The client version of the data set has been modified and the server version of the data set has been deleted;
Delete-Replace: The server version of the data set has been modified and the client version of the data set has been deleted;
Add-Replace: The client application is not aware that the server version of the data set exists and the server version of the data set has been modified;
Replace-Add: The server application is not aware that the client version of the data set exists and the client version of the data set has been modified;
Add-Add: The client and server applications believe that the subject data set is new, albeit both versions of the data set have been assigned the same identifier;
Add-Delete: The client application is not aware that the server version of the data set exists and the server version of the data set has been deleted;
Delete-Add: The server application is not aware that the client version of the data set exists and the client version of the data set has been deleted;
Delete-Delete: The client version and the server version of the data set has been deleted.
   Of course, additional conflict types can be defined within the applications 140A, 140B.

By comparison, pre-defined conflict resolution types can include:
Latest wins;
Client wins;
Server wins;
Update wins (add or replace rather than performing a deletion);
Delete wins (delete rather than performing an add or replace);
Local wins;
Remote wins;
Duplicate;
Merge;
Merge else Duplicate (try to merge, but failing merger perform a duplication);
No resolution (do nothing);
Defer (allow the system to resolve the conflict);
Error (the conflict is an error condition); and,
Already exists (the new data set already exists, so do not add the new data set).
   Again, additional conflict resolutions can be defined with the applications 140A, 140B.

In order to generalize the operation of the conflict resolution logic 200, the adapters 170A, 170B can provide a common interface representing the data set 135 subject to synchronization. The interface provided by the adapters 170A, 170B can be a wrapper interface 145 because the interface can logically wrap the actual data objects in the data set 135 which can be specific to the applications 140A, 140B. The wrapper interface 145 can define how to determine whether or not a data object in the data set 135 has changed since a most recent synchronization, whether or not the object in the data set 135 has been added or deleted since a most recent synchronization, and how to marshal and un-marshal the object in the data set 135 for transmission over the network 130.

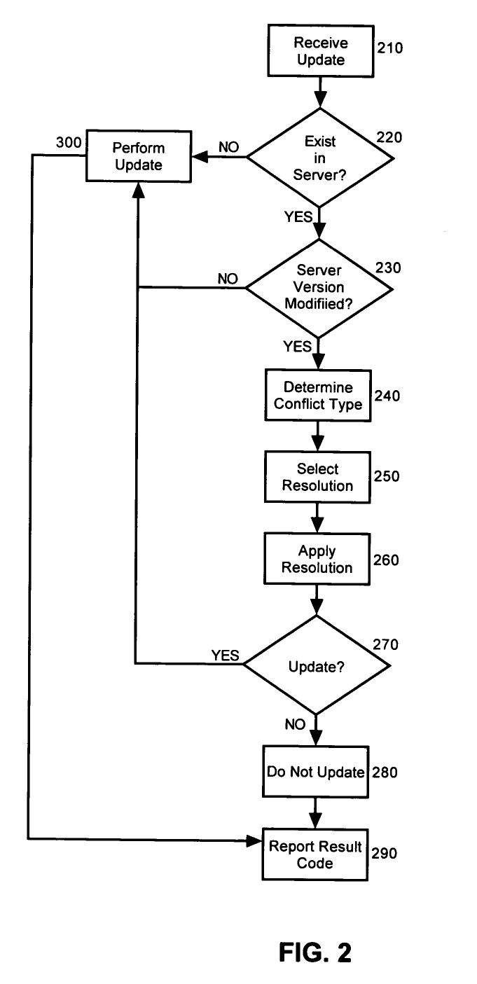

In further illustration of the foregoing inventive methodology, FIG. 2 is a flow chart illustrating a conflict resolution process for use in the synchronization framework of FIG. 1. Beginning in block 210, an update can be received for processing. The update can include a modified data set, a new data set, or an indication of a deleted data set. In decision block 220, it can be determined whether the update exists in the server. If not, there can be no conflict. Accordingly, in block 300 the update can be performed. Otherwise, the process can proceed through decision block 230.

In decision block 230, it can be determined whether the server version of the update had been previously modified since the last synchronization. The foregoing determination can be performed, for instance, by consulting time stamping information for the data set implicated by the update, versioning information for the data set implicated by the update, a modification history for the data set implicated by the update, or some other specific methodology associated with the application. In any case, if it is determined that the server version of the update had not been previously modified since the last synchronization, there can be no conflict. Accordingly, in block 300 the update can be performed. Otherwise, the process can proceed through block 240.

If the server version of the data set implicated by the update has been modified, a conflict necessarily will have arisen as the update itself will indicate that the client version of the data set also has changed. Thus, the conflict must be resolved before the update can be applied. In this regard, the conflict must be resolved in a way which is sensible to the application. Accordingly, as a first step, in block 240 a conflict type for the conflict can be identified. When a conflict type has been determined, in block 250 a conflict resolution rule can be selected.

The selection of a conflict resolution rule can be the responsibility of the application. To that end, a policy can pre-specify the conflict resolution rule to be applied based upon an identified conflict type supported by the application, or the application can implement a conflict resolution callback which can be invoked by the conflict resolution logic in the synchronization framework. In the former circumstance, the conflict resolution policy can be a static table mapping of conflict type to conflict resolution, or a dynamic, formulaic mapping of conflict type to conflict resolution, or a combination of both. In both cases, the application can provide the conflict resolution policy, or the conflict resolution policy can be pre-specified within the framework.

In any case, in block 260 the selected conflict resolution rule can be applied. Based upon the outcome of the application of the conflict resolution, in decision block 270 it can be determined whether an update is permitted. For example, if the server wins, the client update is not to be applied. In contrast, if the client wins, the client update should be applied to the data set in the server implicated by the update. Accordingly, depending upon the determination of decision block 270, in block 300 the update can be performed. Otherwise, the update can be quashed in block 290. In both cases, a result code can be returned to the application. If necessary, the resolution may also result in a modification of the server update that will be sent to the client during the next phase of the synchronization.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A synchronization framework comprising:
a synchronization engine configured for coupling to an application utilizing a data set subject to synchronization with another application;
a synchronization adapter communicatively linked to said synchronization engine; and,
conflict detection and resolution logic disposed within the synchronization framework and configured for communication with one of said synchronization engine and said synchronization adapter.

2. The synchronization framework of claim 1, wherein said conflict detection and resolution logic further comprises a set of rules governing conflict resolution for data sets passed to said synchronization engine.

3. The synchronization framework of claim 2, wherein said rules comprise a static mapping of conflict types to conflict resolutions.

4. The synchronization framework of claim 2, wherein said rules comprise a dynamic mapping of conflict types to conflict resolutions.

5. The synchronization framework of claim 2, wherein said set of rules further a configuration for extension by said application.

6. The synchronization framework of claim 1, wherein the synchronization framework implements a SYNCML framework.

7. In a synchronization framework, a conflict detection and resolution method comprising the steps of:
receiving an update from a client application for application in a server application;
detecting and resolving conflicts for said received update in the synchronization framework; and,
selectively applying said update in said server application. And altering the updates to be sent to the client if necessary, based on the outcome of the conflict resolution.

8. The method of claim 7, wherein said detecting step comprises the step of determining whether a data set implicated by said received update exists in said server application.

9. The method of claim 7, wherein said detecting step comprises the step of determining whether a data set implicated by said received update in said server application has been modified by said server application.

10. The method of claim 7, wherein said resolving step comprises the steps of:
determining a conflict type for said update;
selecting a conflict resolution based upon said determined conflict type; and,
performing said selected conflict resolution; and,
applying said update subsequent to performing said selected conflict resolution.

11. The method of claim 10, wherein said determining step comprises the step of determining a conflict type for said update selected from the group consisting of replace-replace, replace-delete, delete-replace, replace-add, add-replace, add-add, add-delete, delete-add, and delete-delete.

12. The method of claim 10, wherein said selecting step comprises the step of selecting a conflict resolution based upon said determined conflict type wherein said conflict resolution is selected from the group consisting of latest wins, client wins, server wins, update wins, delete wins, local wins, remote wins, duplicate, merge. merge else duplicate, no resolution, defer, error, and already exists.

13. The method of claim 7, further comprising the step of modifying an update to be sent to said client application if it is determined that a resolved one of said conflicts for said received update requires a modification to an update to be sent to said client.

14. A machine readable storage having stored thereon a computer program for conflict detection and resolution in a synchronization framework, the computer program comprising a routine set of instructions which when executed by a machine causes the machine to perform the steps of:
receiving an update from a client application for application in a server application;
detecting and resolving conflicts for said received update in the synchronization framework; and,
selectively applying said update in said server application.

15. The machine readable storage of claim 14, wherein said detecting step comprises the step of determining whether a data set implicated by said received update exists in said server application.

16. The machine readable storage of claim 14, wherein said detecting step comprises the step of determining whether a data set implicated by said received update in said server application has been modified by said server application.

17. The machine readable storage of claim 14, wherein said resolving step comprises the steps of:
determining a conflict type for said update;
selecting a conflict resolution based upon said determined conflict type; and,
performing said selected conflict resolution; and,
applying said update subsequent to performing said selected conflict resolution.

18. The machine readable storage of claim 17, wherein said determining step comprises the step of determining a conflict type for said update selected from the group consisting of replace-replace, replace-delete, delete-replace, replace-add, add-replace, add-add, add-delete, delete-add, and delete-delete.

19. The machine readable storage of claim 17, wherein said selecting step comprises the step of selecting a conflict resolution based upon said determined conflict type wherein said conflict resolution is selected from the group consisting of latest wins, client wins, server wins, update wins, delete wins, local wins, remote wins, duplicate, merge. merge else duplicate, no resolution, defer, error, and already exists.

20. The machine readable storage of claim 17, further comprising an additional set of instructions which when executed by the machine causes the machine to perform an additional step of modifying an update to be sent to said client application if it is determined that a resolved one of said conflicts for said received update requires a modification to an update to be sent to said client.
